(19) United States
(12) Patent Application Publication
(10) Pub. No.: US 2018/0349967 A1
(43) Pub. Date: Dec. 6, 2018

(54) METHOD AND A SYSTEM FOR IDENTIFICATION AND ELIMINATION, AVOIDANCE OR REDUCTION OF PROBLEMS HIDDEN IN A PARTICULAR EXPERIENCE

(71) Applicant: Kumar Vivek, Howrah (IN)

(72) Inventor: Kumar VIVEK, Howrah (IN)

(21) Appl. No.: 15/678,283

(22) Filed: Aug. 16, 2017

(30) Foreign Application Priority Data
May 31, 2017 (IN) 201731019180

(51) Int. Cl. G06Q 30/02; H04L 29/06

(52) U.S. Cl. CPC G06Q 30/0282; H04L 67/42

(57) ABSTRACT

A method for identification and elimination, avoidance or reduction of problems hidden in a particular experience, comprises the steps of providing a plurality of questions from a server (130) to a user device (110), receiving a plurality of questions from the server (130), at the user device (110) and providing a plurality of answers to the respective plurality of questions, to the server (130) from the user device (110), calculating a Workshop Effectiveness Score (WES) at the user device (110) and storing the plurality of questions, the plurality of answers and the WES at the server (130). A system for identification and elimination, avoidance or reduction of problems hidden in a particular experience is also provided.

### FIELD OF THE INVENTION

Embodiment of the present invention relate to assessment of experiences and more particularly to a method and a system for identifying the problems hidden in those experiences and methods to eliminate, avoid and reduce those problems.

### BACKGROUND OF THE INVENTION

Assessment of experiences from customers, employees and other stakeholders of the organization to find out problem areas is an extremely important process of generating new ideas. Very often Problems are hidden in the experiences and it takes a lot of thinking to recognize that a particular part of the experience has a problem to be resolved. The resolution of these problems also needs a lot of thinking.

Assessment of experiences can be used to generate ideas for products and services which can be developed by the organization to generate revenue or improve customer service, streamline operations, resolve employee grievances or improve working conditions.

Other than organizations, assessment of experiences can enable individuals to also do the above things.

Experiences are not frequently analyzed in organizations and when they are done, it is dependent solely on the person assessing the experience to identify whether a particular part of that experience contains a problem.

Therefore there is a need in the art of a method and a system for identifying the points where problems are hidden in those experiences and methods to eliminate, avoid and reduce those problems.

### OBJECT OF THE INVENTION

According to one aspect of the present invention, a method for identification and elimination, avoidance or reduction of problems hidden in a particular experience is provided.

According to another aspect of the present invention, a system for identification and elimination, avoidance or reduction of problems hidden in a particular experience is provided.

### SUMMARY OF THE INVENTION

Embodiments of the present invention aim to provide a method and a system and a method for identification and elimination, avoidance or reduction of problems hidden in a particular experience. According to one aspect of the invention, there is provided a method for identification and elimination, avoidance or reduction of problems hidden in a particular experience, comprising the steps of providing a plurality of questions from a server to a user device, receiving the plurality of questions from the server, at a user device and providing a plurality of answers to the respective plurality of questions to the server from the user device, calculating a Workshop Effectiveness Score (WES) at the user device and storing the plurality of questions, the plurality of answers and the WES at the server.

In accordance with an embodiment of the present invention, the method further comprises a step of calculating WES at the calculation module using a predetermined function of the plurality of answers.

In accordance with an embodiment of the present invention, the method further comprises a step of providing the plurality of questions based on a personal experience of a user during a predetermined time period.

In accordance with an embodiment of the present invention, the method further comprises a step of providing the plurality of questions one by one, in a predetermined sequence.

According to another aspect of the present invention, there is provided a system for identification and elimination, avoidance or reduction of problems hidden in a particular experience comprises an interface module connected with a server and the user device, the calculation module connected with the interface module, the data management module connected with server. Further, the interface module is configured to provide a plurality of questions to the user device and receive a plurality of answers for the respective plurality of questions from the user device. Further, the calculation module is configured to calculate the Workshop Effectiveness Score (WES). Further, the server is configured to store the plurality of questions, the plurality of answers and the WES in the data management module.

In accordance with an embodiment of the present invention, the Workshop Effectiveness Score (WES) is calculated using a predetermined function of the plurality of answers.

In accordance with an embodiment of the present invention, the plurality of questions are based on a personal experience of a user during a predetermined time period.

In accordance with an embodiment of the present invention, the plurality of questions are provided one by one, in a predetermined sequence.

### BRIEF DESCRIPTION OF DRAWINGS

So that the manner in which the above recited features of the present invention can be understood in detail, a more particular description of the invention, briefly summarized above, may have been referred by examples, some of which are illustrated in the appended drawings. It is to be noted, however, that the appended drawings illustrate only typical examples of this invention and are therefore not to be considered limiting of its scope, for the invention may admit to other equally effective examples.

These and other features, benefits, and advantages of the present invention will become apparent by reference to the following text figure, with like reference numbers referring to like structures across the views, wherein:

FIG. 1 illustrates an example of an environment to which various embodiments of the present invention may be implemented;

FIG. 2 illustrates an example of a method for identification and elimination, avoidance or reduction of problems hidden in a particular experience, in accordance with an embodiment of the present invention; and

FIG. 3 illustrates an example of a system for identification and elimination, avoidance or reduction of problems hidden in a particular experience, in accordance with an embodiment of the present invention.

### DETAILED DESCRIPTION

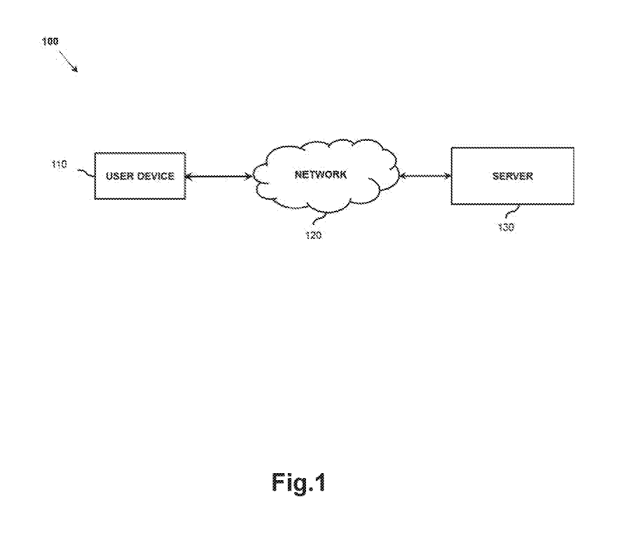

FIG. 1 illustrates an example of an environment (100) to which various embodiments of the present invention may be implemented. An exemplary environment (100) comprises a user device (110) connected to a server (130) through a network (120). In accordance with an embodiment, the user device (110) is selected from, but not limited to, a mobile phone, a laptop, a desktop computer and/or a tablet etc. Further, the network (120) is one of, but not limited to, a Local Area Network (LAN) and/or a Wide Area Network (WAN) etc. Preferably, the network (120) is internet. Also, the server (130) is one of, but not limited to, an in-house server within an organization and/or a cloud based server.

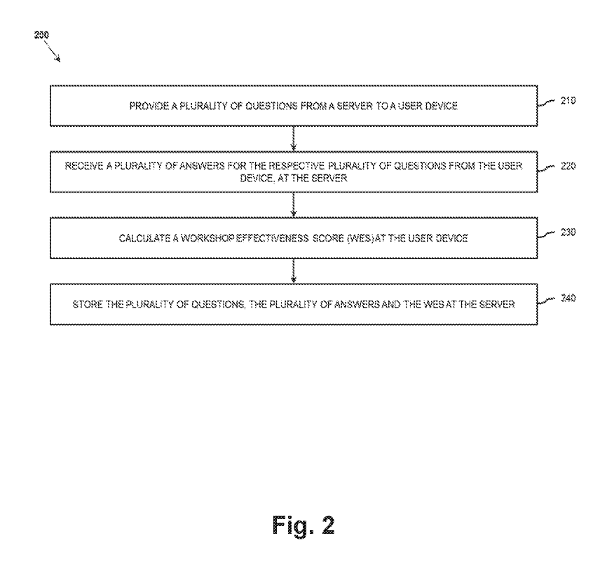

FIG. 2 illustrates an example of a method (200) for identification and elimination, avoidance or reduction of problems hidden in a particular experience, in accordance with an embodiment of the present invention. The method (200) begins at step 210 by providing a plurality of questions from the server (130) to the user device (110).

At step 220, the plurality of questions are received from the server (130), at a user device (110) and a plurality of answers for the respective plurality of questions are provided to the server (130), from the user device (110). In accordance with an embodiment of the present invention, the plurality of questions are provided one by one in a predetermined sequence. And a next question is not provided from the server (130) until an answer is provided from the user device (110) for a previously provided question.

For example, the server (130) provides the user device (110), a question to enter a list of a plurality of incidents and/or activities, of a user of the user device (110), which took place within a predetermined time frame which the user chooses. The plurality of incidents and/or activities may include, but are not limited to, a plurality of observations and experiences of the user. The plurality of incidents and/or activities are labelled as ‘items’.

Then, once the answer is provided by the user, from the user device (110) and received at the server (130), next question is provided by the server (130), to the user device (110), to classify the items as ‘happy’, ‘OK’, ‘unhappy’. The items classified as happy, represent the happy incidents of the plurality of incidents of the user's life that the user enjoyed. The items classified as unhappy, represent the problematic and difficult incidents of the plurality of incidents of the user's life and for which the user needs a solution. The items classified as OK, represent the plurality of activities that the user doesn't specifically feel happy and/or sad about.

For each item classified as ‘OK’, the user is asked a question by server (130) to understand why the item is classified as OK and unhappy. The user uses the below list of pain points (PP) to answer this question from user device (110):
1. Too much involvement of man/woman.
2. Too much involvement of a process or governance.
3. Any technology limitation.
3. Technology making simple task unnecessarily complex.
4. Frequent disconnections throughout an activity or a live experience because of technical dependency.
5. Technology or process has taken away the flavour of joy and spirit from an activity.
6. A monotonous work which does not require brain.
7. The user's experience is not good or paralyzed.
8. The user has people around him/her always taking negative, frustrated or disappointed about it.
9. Simple irritation
10. All the segments of society (rich, poor, middle, lower middle) not equal.
11. A transparency is missing or not maintained.
12. An information is not honestly shared.
13. a lack of cooperation or communication among people.
14. Security risks.
15. A Risk of getting cheated, hacked, robbed etc
16. Poor efficiency or quality.
17. Not easy to understand, practice or teach.
18. A lack of knowledge or dependence on somebody for knowledge based decisions. (for example: lawyer, doctor etc.)
19. Behaviour of some body is intolerable—
20. The user feels humiliated.
21. The user feels foolish.
22. The user's life is not lively.
23. Too much of question/answers oriented.
24. The user needs to remember too much.
25. The user has to reproduce the knowledge again and again
26. Economic problems.
27. An effort-reward ratio is not good.
28. Too much of follow ups or waiting time.
29. A lack of privacy.
30. A lack of secrecy.
31. Self-respect is assassinated.
32. Hierarchy becomes a barrier or a negative factor.
33. A lack of possibilities due to limited knowledge.
34. Proper recognition is not given.
35. Innocence and simplicity is taken for granted or misused.
36. Suppression of information.
37. A wrong interpretation of words or expressions.
38. Inability to communicate or express.
39. Inability to convince.
40. A lack of satisfaction.
41. Impatience.
42. Wastage of time and resources.
43. Creating a tension or a pressure situation
44. Problems in society, law or administration.
45. Misuse of power or money.
46. Trust is compromised.
47. No guaranteed results.
48. Limited to educated people only
49. Violating political, social, family, economic or cultural order/values.
50. Physical world is becoming a limitation.
51. Lack of good, trustworthy and honest people.

The user chooses one or more Pain Points (PP) relevant to his experience and moves the item from the list of the items classified as OK to the list of the items classified as unhappy. Then, once the user provides an answer from the user device (110) to server (130), by categorising the items, the server (130) prepares a separate list each of the items classified as happy, the items classified as ok and the items classified as unhappy. The user device (110) is provided with a question to give a confirmation of the correct classification of the items. Once the confirmation is received by the server (130), the items classified as OK and/or the items classified as unhappy, are termed as Dead Items (DI).

Then, the server (130) provides each item on the list of items classified as unhappy, to the user device (110) along with a question to the user, to identify at least one person associated with that item (unhappy incident). The at least one person is called ‘stakeholder’. The stakeholder can be a living person or any non-living object involved in that item. Then the user using the user device (110) provides one or more stakeholders to the server (130).

After that, the server (130) provides a question to identify at least one of the one or more stakeholders from the list, who is contributing to the unhappiness and what is he/she doing to contribute unhappiness.

Then, after receiving the answer, the server (130) will provide a question to the user device (110) that is, will the at least one of the one or more stakeholders contribute in removing and/or reducing the unhappiness? If the answer to the question is ‘yes’, then server (130) will provide next of the one or more stakeholders. If the answer to the question is ‘no’, the server (130) will provide a question to the user device (110) for the user to think of at least one solution for the at least one of the one or more stakeholders. The at least one solution will be marked as a Stakeholder Solutions (SS).

Then, after analysing, all of the one or more stakeholders one by one, the server (130) provides a question of confirmation that is the user able to reduce and/or avoid the impact of the item classified as unhappy.

If the answer provided by the user to the previous question is ‘Yes’, then the item classified as unhappy, is removed from the list of the items classified as unhappy, as the user has found a solution.

If the answer is ‘No’, then the server (130) provides a question and a scenario to the user to imagine a world where the item classified as unhappy doesn't exist and then think of a solution, having got the clarity about the root cause of the item classified as unhappy. This will be called ‘Your World’ solution.

At step 230, a Workshop Effectiveness Score (WES) is calculated at the user device (110) using a predetermined function of the plurality of answers.

The predetermined function is given as:

WES=[((1.75*UHₙ|Iₙ)+(OK_{n/}Iₙ))(SSₙ+YWₙ)(UHₙ+OKₙ)]*Iₙ²/(N*DIₙ)
Where UHₙ=No. of items classified as Unhappy
   OKₙ=No. of items classified as OK
   Iₙ=Total No. of Items
   SSₙ=No. of Stakeholder Solutions
   YWₙ=No. of Your World Solutions
   DIₙ=No. of Dead Items
   N=No. of users

In accordance with an embodiment of the present invention, the method can also be performed with a plurality of user devices (110) connected to the server (130) through the network (120). In the above mentioned example, number of users is 1, so N=1.

At step 240, the plurality of questions, the plurality of answers and the WES are stored at the server (130).

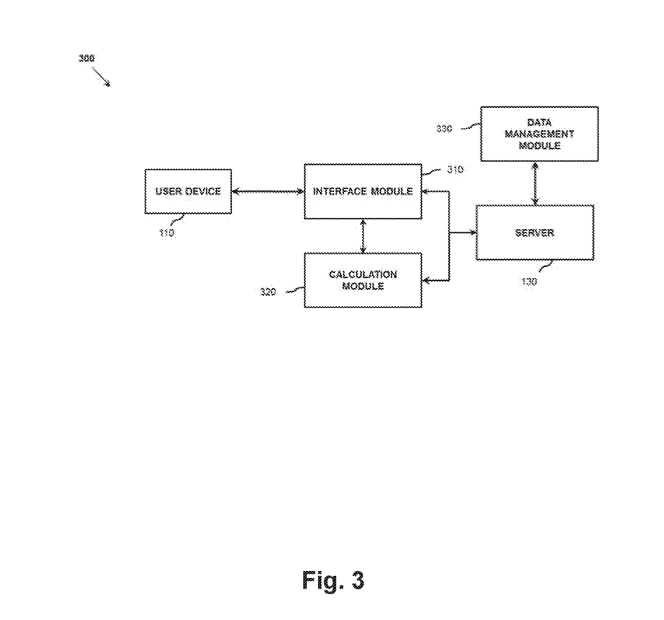

FIG. 3 illustrates an example of a system (300) for identification and elimination, avoidance or reduction of problems hidden in a particular experience. The system (300) having the user device (110) and the server (130), comprises an interface module (310), a calculation module (320) and a data management module (330). The interface module (310) acts as communication means between the server (130) and the user device (110). The interface module (310) is configured to provide the plurality of questions, to the user device (110). As mentioned above, the plurality of questions are aimed at identifying the problem and/or item classified as unhappy from the user's experience within a predetermined time period and finding the solution for the item classified as unhappy.

Further, the interface module (310) is configured to receive a plurality of answers for the respective plurality of questions from the user device (110) and transmit them to the server (130). The plurality of answers may be, but are not limited to, one word, plurality of words, one sentence and/or a plurality of sentences according to the corresponding plurality of questions. Also, after the user has completed the method (200), the interface module (310) is configured to restart the method (200) if the interface module (310) is accessed again from the user device (110). In accordance with an embodiment of the present invention, the completion of the method (200) is indicated by, a user exiting the interface module (310) on the user device (110) while the plurality of questions and/or the plurality of answers for the respective plurality are being provided; or after the WES is provided to the user at the user device (110).

Further, the calculation module (320) is configured to calculate the Workshop Effectiveness Score (WES). The Workshop Effectiveness Score (WES) is calculated using the predetermined function of the plurality of answers. WES represents an efficiency of the method (200). WES tells how much, the method (200) has been able to help the one or more users in identifying the problems and finding the appropriate solution.

Further, the data management module (330) is configured to store as well as provide the server (130) (at a predetermined instance of time) with the plurality of questions, the plurality of answers and the WES as data. The data management module (330) comes in handy, if the user wants to re-access and/or refer to the data in future.

Advantages of using the present invention are removing the dependency of a user on others to help in solving his/her problems. The present invention acts more a like a guide for the user and helps the user to understand their problem, find the root cause of the problem and find a solution to the problem. Different people have different problems; therefore, the present invention doesn't necessarily provide pre-programmed solutions to the user but guides the user through the whole method (200) and shows him/her a step by step path for finding the solution himself/herself. This also removes any dependency of the user on a computer program if the user faces a problem in future. Moreover, a user might be more comfortable in sharing his/her experience with the present invention than with a third person. Therefore, the present invention is a pathway to a life free of stress.

Various modifications to these embodiments are apparent to those skilled in the art from the description. The principles associated with the various embodiments described herein may be applied to other embodiments. Therefore, the description is not intended to be limited to the embodiments but is to be providing broadest scope of consistent with the principles and the novel and inventive features disclosed and/or suggested herein. Accordingly, the invention is anticipated to hold on to all other such alternatives, modifications, and variations that fall within the scope of the present invention.

I claim:

1. A method for identification and elimination, avoidance or reduction of problems hidden in a particular experience, comprising the steps of:
providing a plurality of questions from a server (130) to a user device (110);
receiving a plurality of questions from the server (130), at a user device (110) and providing a plurality of answers to the respective plurality of questions to the server (130) from the user device (110);
calculating a Workshop Effectiveness Score (WES) at the user device (110); and
storing the plurality of questions, the plurality of answers and the WES at the server (130).

2. The method as claimed in claim 1, further comprising a step of calculating WES at the server (130) using a predetermined function of the plurality of answers.

3. The method as claimed in claim 1, further comprising a step of providing the plurality of questions based on a personal experience of a user during a predetermined time period.

4. The method as claimed in claim 1, further comprising a step of providing the plurality of questions one by one, in a predetermined sequence.

5. A system for identification and elimination, avoidance or reduction of problems hidden in a particular experience, comprising:
an interface module (310) connected with a server (130) and a user device (110);
a calculation module (320) connected with the interface module (310);
a data management module (330) connected with server (130);
wherein the interface module (310) is configured to:
provide a plurality of questions to the user device (110); and
receive a plurality of answers for the respective plurality of questions from the user device (110);
wherein the calculation module (320) is configured to calculate a Workshop Effectiveness Score (WES); and
wherein the server (130) is configured to store the plurality of questions, the plurality of answers and the WES in the data management module (330).

6. The system as claimed in claim 5, wherein the Workshop Effectiveness Score (WES) is calculated using a predetermined function of the plurality of answers.

7. The system as claimed in claim 5, wherein the plurality of questions are based on a personal experience of a user during a predetermined time period.

8. The system as claimed in claim 5, wherein the plurality of questions are provided one by one in a predetermined sequence.
